(19) United States
(12) Patent Application Publication
(10) Pub. No.: US 2016/0379198 A1
(43) Pub. Date: Dec. 29, 2016

(54) COMMODITY SALES DATA PROCESSING APPARATUS

(71) Applicant: TOSHIBA TEC KABUSHIKI KAISHA, Tokyo (JP)

(72) Inventor: Makoto Hiyoshi, Izunokuni (JP)

(21) Appl. No.: 15/187,997

(22) Filed: Jun. 21, 2016

(30) Foreign Application Priority Data
Jun. 29, 2015 (JP) 2015-130246

(51) Int. Cl. G06Q 20/20; G06K 7/10; G07G 5/00

(52) U.S. Cl. CPC G06Q 20/209; G07G 5/00; G06K 7/10821

(57) ABSTRACT

A commodity sales data processing apparatus receives the input of a customer identification data for identifying a customer, and retrieves a customer data storage section in which a customer data containing an issue-classification of a receipt is set in advance in association with the customer identification data for identifying each customer to determine the issue-classification contained in the customer data set in association with the customer identification data. Further, the commodity sales data processing apparatus selectively executes a receipt issuing processing for issuing the receipt according to the determined issue-classification.

### CROSS-REFERENCE TO RELATED APPLICATION

This application is based upon and claims the benefit of priority from Japanese Patent Application No. 2015-130246, filed Jun. 29, 2015, the entire contents of which are incorporated herein by reference.

### FIELD

Embodiments described herein relate generally to a commodity sales data processing apparatus such as a POS terminal.

### BACKGROUND

There is a known commodity sales data processing apparatus such as a POS terminal which includes a camera for capturing a face image of a customer, specifies age bracket of the customer from the image of the customer captured by the camera and issues a receipt printed with a printer according to a character size corresponding to the age bracket.

However, this kind of the apparatus does not necessarily issue a receipt desired by the customer.

### DESCRIPTION OF THE DRAWINGS

FIG. 1 is an overall view illustrating the structure of main portions of a POS system including a POS terminal according to an embodiment;

FIG. 2 is a schematic diagram illustrating an example of the data structure of a commodity master file managed by a server according to the embodiment;

FIG. 3 is a schematic diagram illustrating an example of the data structure of a customer master file managed by the server according to the embodiment;

FIG. 4 is a block diagram illustrating the structure of main portions of the POS terminal according to the embodiment;

FIG. 5 is a schematic diagram illustrating a main memory area formed on a RAM of the POS terminal according to the embodiment;

FIG. 6 is a plane view illustrating an example of a receipt printed with a normal character and issued by the POS terminal according to the embodiment;

FIG. 7 is a plane view illustrating an example of a receipt printed with an enlarged character and issued by the POS terminal according to the embodiment;

FIG. 8 is a plane view illustrating an example of a voucher (formal receipt) printed and issued by the POS terminal according to the embodiment; and

FIG. 9 is a flowchart illustrating the main processing procedure of a commodity sales data processing executed by a CPU of the POS terminal according to the embodiment.

### DETAILED DESCRIPTION

In accordance with an embodiment, a commodity sales data processing apparatus comprises an input module, a determination module and a control module. The input module receives the input of a customer identification data for identifying a customer. The determination module retrieves, according to the customer identification data input via the input module, a customer data storage section in which a customer data containing an issue-classification of a receipt is set in advance in association with the customer identification data of each customer to determine the issue-classification contained in the customer data set in association with the customer identification data. The control module selectively executes a receipt issuing processing for issuing the receipt according to the issue-classification determined by the determination module.

An embodiment is described below with reference to the accompanying drawings.

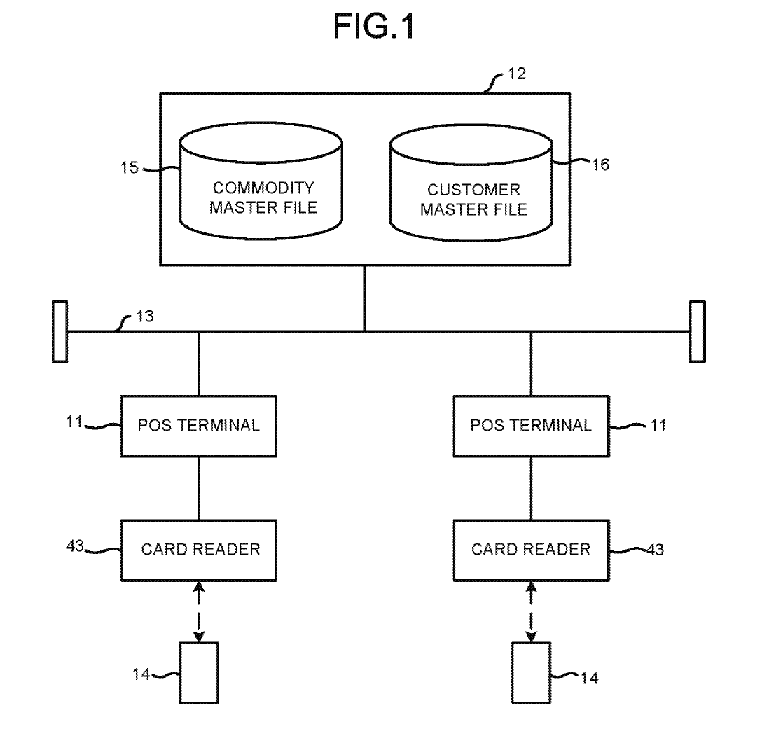

FIG. 1 is an overall view illustrating the structure of main portions of a POS (Point Of Sales) system according to the present embodiment. In the POS system, as shown in FIG. 1, a plurality of POS terminals 11, i.e., a commodity sales data processing apparatus, and a server 12 serving as a host device of each POS terminal 11 are connected with each other via a communication network 13 such as a LAN (Local Area Network) to perform a mutual communication.

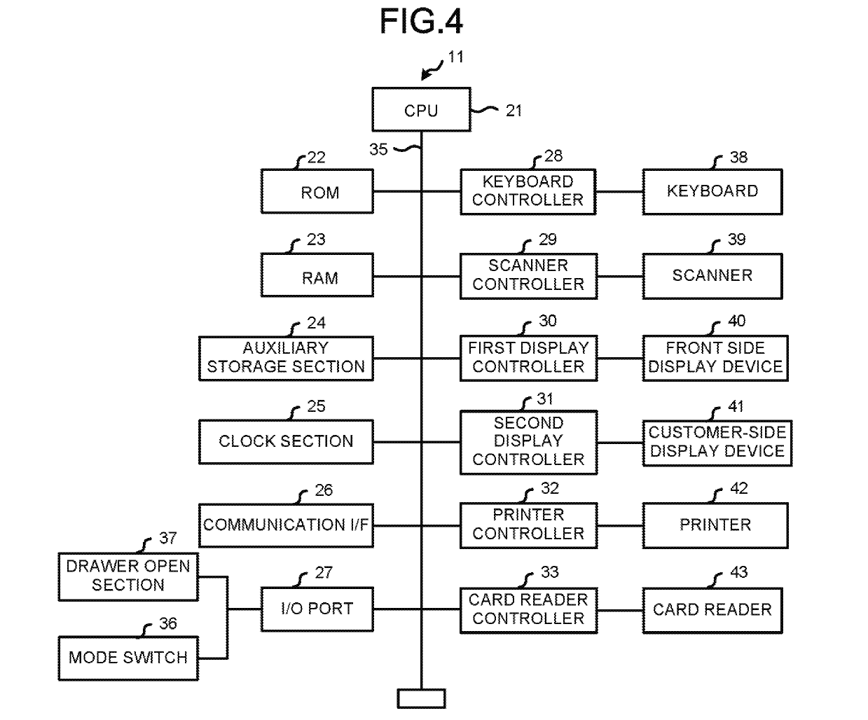

The POS terminals 11 are respectively provided with a card reader 43 (refer to FIG. 4) for inputting a card data recorded in a customer card 14. In the customer card 14, at least a customer code serving as a customer identification data for identifying the customer registered as a member is recorded.

The server 12 manages a commodity master file 15 and a customer master file 16.

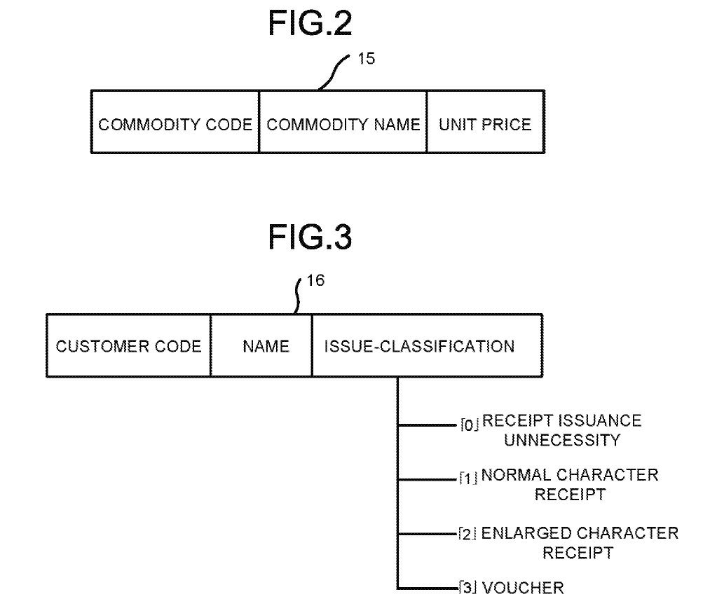

FIG. 2 is a schematic diagram illustrating the main data structure of the commodity master file 15. As shown in FIG. 2, the commodity master file 15 stores a commodity data record including a commodity name, a unit price and the like of a commodity in association with a commodity code serving as a commodity identification data assigned to each commodity used to identify each commodity sold in a retail store. The commodity master file 15 constitutes a commodity data storage section.

The server 12 extracts a commodity data including at least a commodity code, a commodity name and a unit price needed for executing a commodity sales registration processing from each commodity data in the commodity master file 15 to create a commodity data file. Then, the server 12 distributes the commodity data file to each POS terminal 11 via the communication network 13 at a predetermined time.

FIG. 3 is a schematic diagram illustrating the main data structure of the customer master file 16. As shown in FIG. 3, the customer master file 16 stores a customer data record including a name of a customer, an issue-classification and the like in association with a customer code serving as a customer identification data for identifying each customer registered as a member.

The issue-classification is information used to identify a receipt issuance condition desired by a customer. The receipt issuance condition has four patterns including an “unnecessity of receipt issuance” indicating that the issuance of a receipt is unnecessary, a “normal character receipt” indicating that the issuance of a receipt with normal-size characters is necessary, an “enlarged character receipt” indicating that the issuance of a receipt with enlarged-size characters larger than the normal-size characters is necessary and a “voucher” indicating that the issuance of a receipt in a formal format is necessary.

In the present embodiment, the issue-classification of the “unnecessity of receipt issuance” is set to “0”, the issue-classification of the “normal character receipt” to “1”, the issue-classification of the “enlarged character receipt” to “2” and the issue-classification of the “voucher” to “3”. The customer master file 16 constitutes a customer data storage section.

The issue-classification relating to the issuance of such a receipt is set in the customer master file 16 according to desire of the customer registered as a member.

FIG. 4 is a block diagram illustrating the structure of main portions of the POS terminal 11. The POS terminal 11 is loaded with a CPU (Central Processing Unit) 21 acting as a main control section. Further, the POS terminal 11 is provided with a ROM (Read Only Memory) 22 in which fixed data such as a control program used by the CPU 21 to control each section is pre-stored, a RAM (Random Access Memory) 23 in which various data memory areas needed for carrying out a registration processing of commodity sales data are formed, an auxiliary storage section 24, a clock section 25 that counts a current date and time, a communication interface (I/F) 26 that controls a data communication with the server 12 connected therewith via the communication network 13, an I/O port (Input/Output) 27, a keyboard controller 28, a scanner controller 29, a first display controller 30, a second display controller 31, a printer controller 32 and a card reader controller 33, which are connected with the CPU 21 through a bus line 35 such as an address bus, a data bus and the like.

Furthermore, the POS terminal 11 connects a mode switch 36 and a drawer opening section 37 with the I/O port 27, connects a keyboard 38 with the keyboard controller 28, connects a scanner 39 with the scanner controller 29, connects a front side display device 40 with the first display controller 30, connects a customer-side display device 41 with the second display controller 31, connects a printer 42 with the printer controller 32 and connects a card reader 43 with the card reader controller 33.

The ROM 22 also stores a font file. In the font file, a normal character font and an enlarged character font whose character is larger than that of the normal character font.

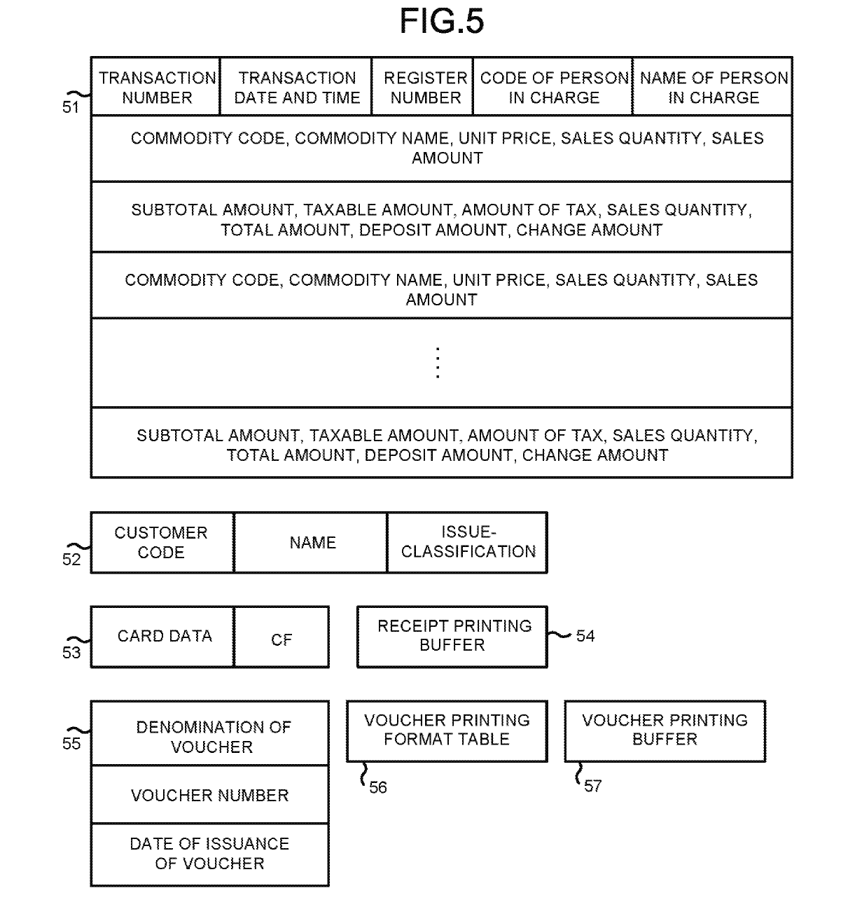

In the RAM 23, as shown in FIG. 5, various memory areas including a transaction buffer 51, a receipt issuance table 52, a card buffer 53, a receipt printing buffer 54, a voucher buffer 55, a voucher printing format table 56 and a voucher printing buffer 57 are formed.

The transaction buffer 51 stores a transaction data record including a transaction attribute data consisting of items such as a transaction number, a transaction date and time, a register number, a code of person in charge and a name of person in charge in one commodity transaction, a registration commodity data consisting of items such as a commodity code, a commodity name, a unit price, a sales quantity and a sales amount and a settlement data consisting of items such as a subtotal amount, a taxable amount, an amount of tax, a sales quantity, a total amount, a deposit amount and a change amount. The transaction buffer 51 constitutes a transaction data storage section.

The receipt issuance table 52 stores the name of a customer and an issue-classification relating to the issuance of a receipt in association with a customer code.

The card buffer 53 stores a card data containing a customer code input from the customer card 14, and a card flag CF. The card flag CF is used to identify whether or not it is a commodity transaction with the customer who presents his or her customer card 14.

In the embodiment, the card flag CF is set to “1” if it is a commodity transaction with the customer having a customer card 14.

The receipt printing buffer 54 stores a receipt print data printed by the printer 42.

The voucher buffer 55 stores data of each item such as a denomination, a voucher number and an issue date printed on a voucher.

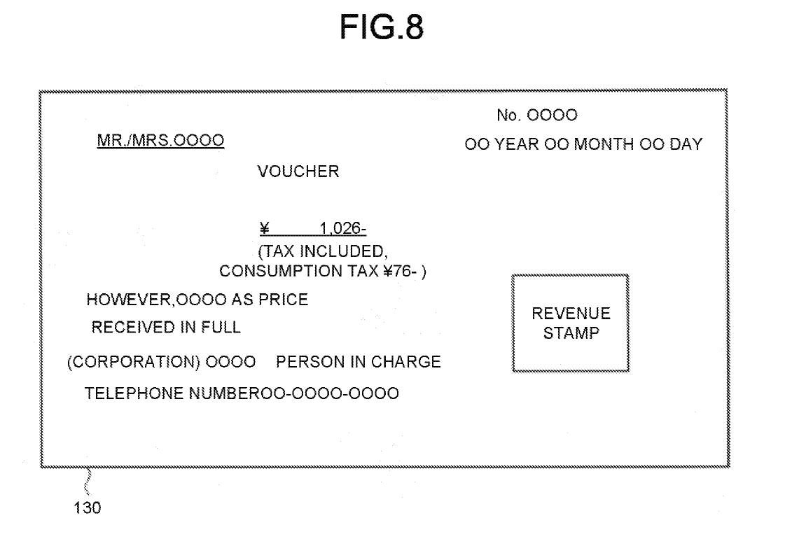

The voucher printing format table 56 stores an elongated voucher printing format data printed with characters which are rotated at a right angle leftwards with respect to a receipt paper. The voucher printing format contains a ‘recipient name’ column, a ‘denomination’ column, a ‘revenue stamp’ column, a voucher number and a ‘date’ column (refer to FIG. 8).

The voucher printing buffer 57 stores a voucher data printed by the printer 42.

The auxiliary storage section 24 is, for example, an HDD (Hard Disk Drive) or an SSD (Solid State Drive).

The auxiliary storage section 24 saves a data used by the CPU 21 to control each section and a data generated under the control of the CPU 21. The auxiliary storage section 24 further stores application programs.

At the time of the activation of the POS terminal 11, part or all of the data stored in the auxiliary storage section 24 is copied on the RAM 23. The CPU 21 executes each processing according to each data copied on the RAM 23.

The I/O port 27 inputs a mode signal of the mode switch 36. The mode switch 36 is an operation switch that instructs the CPU 21 to execute a job mode selected from various job modes such as a “registration”, a “verification” and a “settlement”.

Incidentally, the “registration” refers to a job mode in which if a commodity code is input via a commodity code input module of the keyboard 38 or the scanner 39, a unit price data corresponding to the commodity code is called and a data processing relating to the commodity sales based on the unit price data is carried out. The “verification” refers to a job mode of outputting a report of a sales totalization data obtained from the commodity sales data processed through the “registration” job. The “settlement” refers to a job mode of clearing the sales totalization data after outputting the report of the sales totalization data as similar to the “verification” job.

Further, the I/O port 27 outputs an opening drive signal to the drawer opening section 37 that opens the drawer (not shown) automatically. Upon receiving the opening drive signal, the drawer opening section 37 carries out an operation of opening the drawer automatically.

The keyboard controller 28 acquires a key signal corresponding to a key operated on the keyboard 38 and outputs the key signal to the CPU 21.

Various function keys such as a PLU (Price Look Up) key, a department key, a ‘*’ key, a discount key, a clear key, a subtotal key, a deposit/cash total key and a credit key are arranged on the keyboard 38, in addition to numeric keys “00” and “0”˜“9”.

The PLU key is used to instruct that a numeric data is a commodity code. The subtotal key is used to instruct an output of total registered as a commodity transaction with one customer. The deposit/cash total key and the credit key are closing keys used to declare the close of the commodity transaction with one customer. The deposit/cash total key is the closing key of a transaction with cash and the credit key is the closing key of a transaction with credit.

The commodity code can be input through the numeric keys and the PLU key on the keyboard 38, and the PLU key and the numeric keys constitute a commodity code input module.

The scanner controller 29 acquires a barcode data scanned by the scanner 39 to output the barcode data to the CPU 21.

The scanner controller 29 and the scanner 39 also constitute the commodity code input module.

The first display controller 30 controls the front side display device 40 to selectively display various screens according to an instruction of the CPU 21.

The second display controller 31 controls the customer-side display device 41 to display characters/images corresponding to various kinds of information to a customer on the customer-side display device 41 according to an instruction of the CPU 21.

The printer controller 32 controls the printer 42 according to an instruction of the CPU 21.

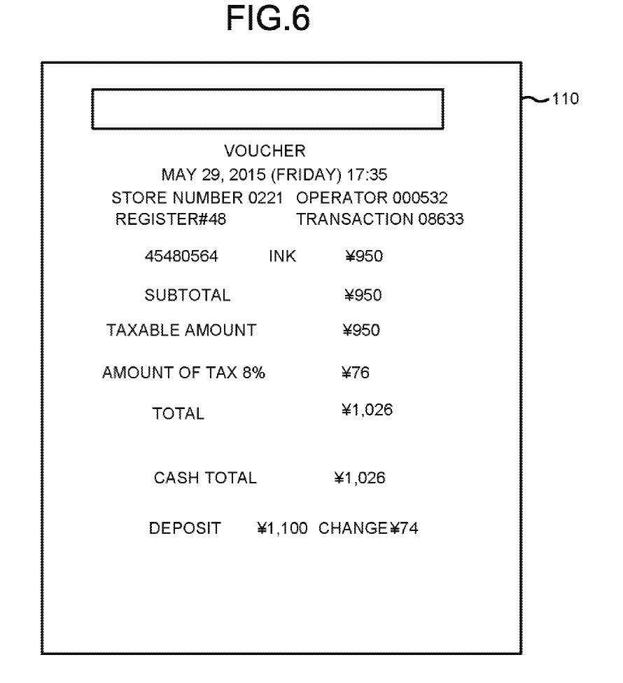

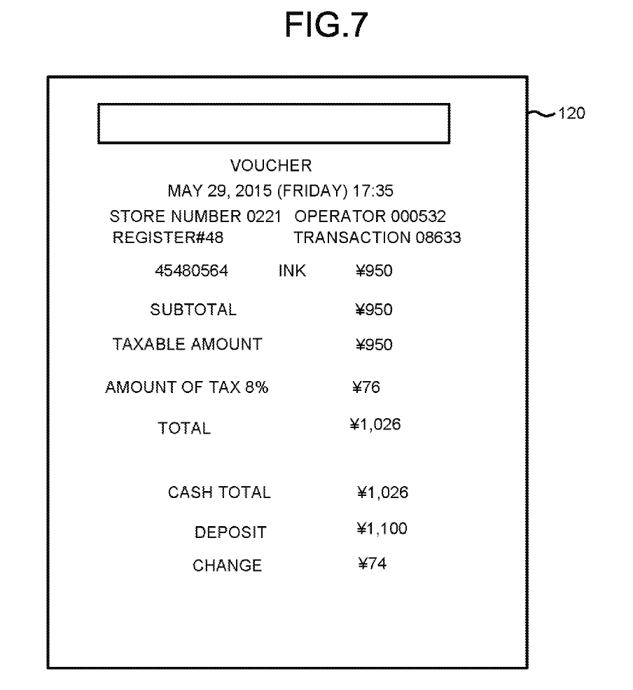

The printer 42, which is, for example, a thermal printer, prints receipts 110 and 120 on the basis of the receipt print data in the receipt printing buffer 54 (refer to FIG. 6 and FIG. 7). Further, the printer 42 prints a voucher 130 on the basis of a voucher print data in the voucher printing buffer 57 (refer to FIG. 8).

The card reader controller 33 acquires a card data through the card reader 43 and outputs the card data to the CPU 21. The card reader 43 inputs the card data recorded on the customer card 14.

The CPU 21 of the POS terminal 11 with such a structure stores the control program for realizing the commodity sales data processing in, for example, the ROM 23.

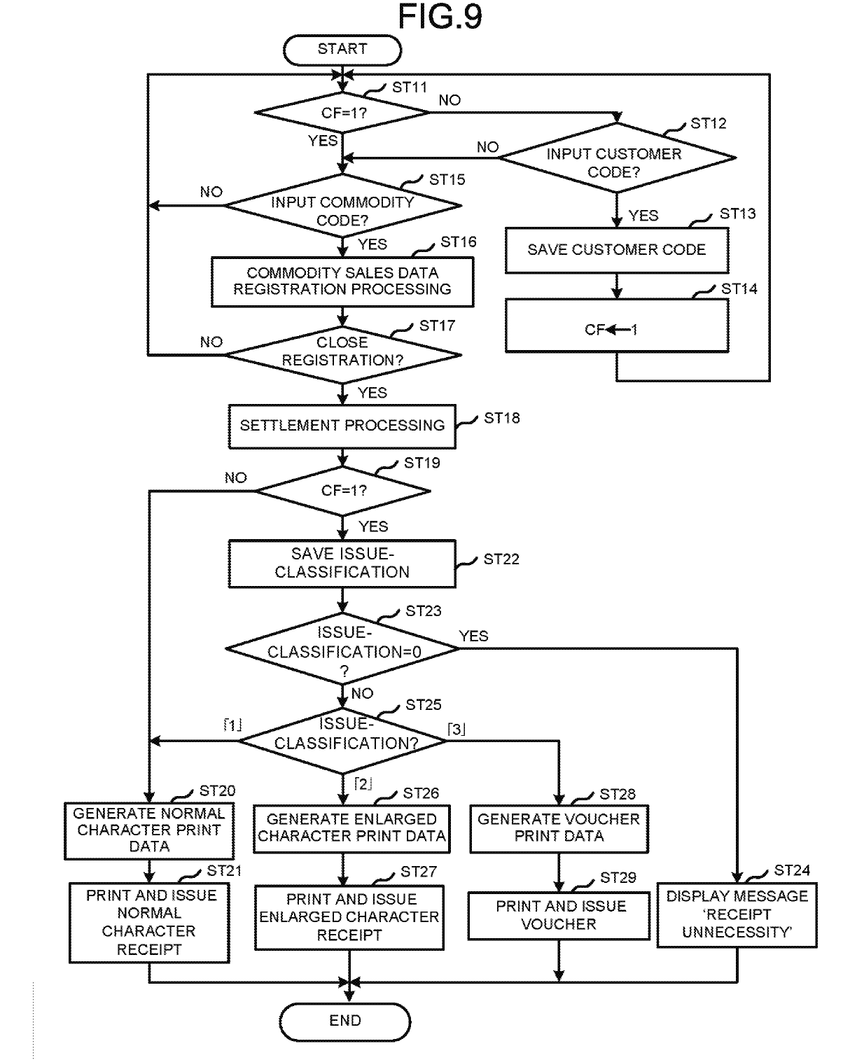

FIG. 9 is a flowchart illustrating the main processing procedure of the CPU 21 at the time of processing the commodity transaction with one customer.

Firstly, the CPU 21 determines whether or not the card flag CF is set to “1” (ACT ST11). The card flag CF is set to “1” at the time of the commodity transaction with a member and stored in the card buffer 53 of the RAM 23. Originally, the card flag CF is reset to “0”.

If it is determined that the card flag CF is not set to “1” (NO in ACT ST11), the CPU 21 further determines whether or not the customer code of the customer card 14 is input by the card reader 43 (ACT ST12).

If it is determined that the customer code is not input (NO in ACT ST12), the CPU 21 determines whether or not the commodity code is input (ACT ST15).

If it is determined that the commodity code is not input (NO in ACT ST15), the CPU 21 returns to a determination processing of the card flag CF (ACT ST11). Thus, in a state where the card flag CF is not set to “1”, the CPU 21 waits for that the customer code is input or that the commodity code is input.

If the customer code is input by the card reader 43 (YES in ACT ST12), the CPU 21 saves the customer code in the card buffer 53 of the RAM 23 (ACT ST13).

Then, the CPU 21 sets the card flag CF to “1” (ACT ST14). The CPU 21 returns to the processing in ACT ST11. At this time, as the card flag CF is set to “1”, the CPU 21 proceeds to the processing in ACT ST15.

The CPU 21 determines whether or not the commodity code is input (ACT ST15). If it is determined that the commodity code is not input (NO in ACT ST15), the CPU 21 waits for that the commodity code is input.

If the commodity code is input through the scanning by the scanner 39 or a predetermined key on the keyboard 38 serving as the commodity code input module (YES in ACT ST15), the CPU 21 reads the commodity data record including the commodity name, the unit price and the like preset in the commodity master file 15 according to the input commodity code. Furthermore, the CPU 21 calculates the sales amount by multiplying the sales quantity by the unit price to create a commodity registration data record including the commodity name, the sales quantity and the sales amount in association with the commodity code and saves the commodity registration data record in the transaction buffer 51 of the RAM 23 (ACT ST16).

Afterwards, the CPU 21 determines whether or not a registration closing key is input (ACT ST17). Before the registration closing key is input (NO in ACT ST17), in a case in which a next commodity code is input (YES in ACT ST15), the CPU 21 executes the processing in ACT ST16 again.

If it is determined that the registration closing key is input (YES in ACT ST17), as the close of one commodity transaction is declared, the CPU 21 executes a settlement processing (ACT ST18). In other words, the CPU 21 carries out a registration processing of sales data of commodities sold in one commodity transaction according to the transaction data stored in the transaction buffer 51.

The CPU 21 subtracts the total amount of one commodity transaction from the deposit amount to calculate the change amount. Then, the CPU 21 displays the change amount on the front side display device 40 and the customer-side display device 41.

Furthermore, the CPU 21 saves the transaction data of the total amount, deposit amount and change amount generated through the settlement processing in the transaction buffer 51.

If the settlement processing is terminated, the CPU 21 checks the card flag CF (ACT ST19).

If the card flag CF is reset to “0” (NO in ACT ST19), the CPU 21 executes a receipt issuing processing based on the normal character font because of a commodity transaction with a non-member. In other words, the CPU 21 generates normal character receipt data with the use of the normal character font of the receipt printing format and saves the normal character receipt data in the receipt printing buffer 54 (ACT ST20).

Next, the CPU 21 controls the printer 42 via the printer controller 32 to print the normal character receipt data saved in the receipt printing buffer 54 on a receipt paper with the use of the normal character font stored in the ROM 22 and issues the receipt as a normal character receipt 110 (ACT ST21: normal printing issuance control module).

Then, the CPU 21 terminates the commodity sales data processing of the commodity transaction with one customer.

On the other hand, it is determined that the card flag CF is set to “1” (YES in ACT ST19), the CPU 21 refers to the customer master file 16 according to a customer code saved in the card buffer 53, reads the customer data such as the name, the issue-classification and the like preset in association with the customer code and saves the customer data in the receipt issuance table 52 (ACT ST22) because of the commodity transaction with a customer registered as a member. The CPU 21 checks the issue-classification saved in the receipt issuance table 52 in ACT ST23.

If the issue-classification in the receipt issuance table 52 is set to “0” (YES in ACT ST23), the CPU 21 displays a message “unnecessity of receipt” on the front side display device 40 and the customer-side display device 41 in ACT ST24 and terminates the commodity sales data processing of one commodity transaction without issuing the receipt.

On the other hand, if the issue-classification is not set to “0” (NO in ACT ST23), the CPU 21 checks that the issue-classification of the receipt is set to “1”, “2” or “3” in ACT ST25.

If the issue-classification is “1”, the CPU 21 proceeds to the foregoing processing in ACT ST20.

On the other hand, if the issue-classification is “2” in the processing in ACT ST25, the CPU 21 executes the receipt issuing processing. The CPU 21 generates the enlarged character receipt data with the use of the enlarged character format of the receipt printing format and saves it in the receipt printing buffer 54 (ACT ST26).

Next, the CPU 21 controls the printer 42 via the printer controller 32 to print the enlarged character receipt data saved in the receipt printing buffer 54 on a receipt paper with the use of the enlarged character font stored in the ROM 22 and issues the receipt paper as an enlarged character receipt 120 (ACT ST27: enlarged character printing issuance control module).

Then, the CPU 21 terminates the commodity sales data processing of the commodity transaction with one customer.

Further, if the issue-classification is in the processing in ACT ST25, the CPU 21 executes the voucher issuing processing. The CPU 21 generates a voucher print data with the use of the voucher printing format data in the voucher printing format table 56 and saves it in the voucher printing buffer 57 (ACT ST28).

Next, the CPU 21 controls the printer 42 via the printer controller 32 to print the voucher print data saved in the voucher printing buffer 57 on a receipt paper with the use of the normal character font stored in the ROM 22 and issues the receipt paper as the voucher 130 (ACT ST29: voucher printing issuance control module).

Then, the CPU 21 terminates the commodity sales data processing of the commodity transaction with one customer.

In this way, according to each POS terminal 11 of the present embodiment, it is possible to classify the operation of the printer according to the receipt issuance condition desired by a customer that the receipt is not issued, or the receipt is issued with normal-size characters or with enlarged-size characters.

In the foregoing embodiment, the receipt printing issuance is carried out by separately using two kinds of character fonts consisting of the normal character font and the enlarged character font; however, another method may be applicable in which the size of the character is set to a reduced size with the use of a reduced character font to issue a reduced character receipt and a reduced character voucher.

In the foregoing embodiment, the items printed on the receipt with the normal character font is equal to these printed on the receipt with the enlarged character font; however, for example, a part of the items printed on the receipt with the normal character font may be omitted in the receipt printed with the enlarged character font to save the length of the receipt.

Further, in addition to the issuance of the receipt, for example, in the issuance of a coupon, the coupon may be printed with the normal character size font or the enlarged character size font.

The present invention is not limited to the foregoing embodiments, and in the realization stage, each structure element may be modified properly to be specified without departing from the spirit of the present invention.

For example, in the foregoing embodiment, the commodity master file 15 may not be stored in the server 12 but is stored in the auxiliary storage section 24 of the POS terminal 11.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity sales data processing apparatus which is capable of issuing a receipt obtained by printing a transaction data of one commodity transaction on a receipt paper, comprising:
an input module configured to receive the input of a customer identification data for identifying a customer;
a determination module configured to, according to the customer identification data input via the input module, retrieve a customer data storage section in which customer data containing an issue-classification of the receipt is set in advance in association with the customer identification data of each customer to determine the issue-classification contained in the customer data set in association with the customer identification data; and
a control module configured to selectively execute a receipt issuing processing for issuing the receipt according to the issue-classification determined by the determination module.

2. The commodity sales data processing apparatus according to claim 1, wherein the receipt issuing processing includes a plurality of receipt issuing processing.

3. The commodity sales data processing apparatus according to claim 2, wherein one of the receipt issuing processing executed by the control module according to the issue-classification is a processing of issuing the receipt printed with a normal character size font.

4. The commodity sales data processing apparatus according to claim 2, wherein one of the receipt issuing processing executed by the control module according to the issue-classification is a processing of issuing the receipt printed with an enlarged character size font.

5. The commodity sales data processing apparatus according to claim 2, wherein one of the receipt issuing processing executed by the control module according to the issue-classification is a processing of issuing the receipt printed in a predetermined voucher format.
